(19) United States
(12) Patent Application Publication
(10) Pub. No.: US 2025/0070987 A1
(43) Pub. Date: Feb. 27, 2025

(54) SYSTEMS, METHODS, AND MEDIA FOR ESTABLISHING AUTHENTICITY OF IMAGE CONTENT

(71) Applicant: The Trustees of Columbia University in the City of New York, New York, NY (US)

(72) Inventors: Mohit Gupta, Madison, WI (US); Suman Jana, Bronx, NY (US); Vishal Misra, New York, NY (US)

(21) Appl. No.: 18/811,230

(22) Filed: Aug. 21, 2024

Related U.S. Application Data
(60) Provisional application No. 63/534,732, filed on Aug. 25, 2023.

(51) Int. Cl. H04L 9/32; H04L 9/00

(52) U.S. Cl. CPC H04L 9/3247; H04L 9/50

(57) ABSTRACT

Mechanisms, including systems, methods, and media for establishing authenticity of image content are provided, the methods including: capturing an image using a camera; digitally signing the image using the camera to create a digital signature; and storing a first copy of the image in remote storage with the digital signature. In some embodiments, the image and the digital signature are stored in a blockchain. In some embodiments, the methods further comprise: retrieving a second copy of the image; and determining whether the second copy of the image is authentic based on the digital signature. In some embodiments, the methods further comprise generating an indicator that indicates to a person whether the second copy of the image is authentic. In some embodiments, the methods further comprise storing an indicator of edits made in the edited copy in the blockchain.

### CROSS-REFERENCE TO RELATED APPLICATION

This application claims the benefit of U.S. Provisional Patent Application No. 63/534,732, filed Aug. 25, 2023, which is hereby incorporated by reference herein in its entirety.

### BACKGROUND

In an era of rampant misinformation, it has become imperative to develop robust methods for verifying the authenticity of image content. For example, it is common to find deep fakes videos that allegedly show a person saying or doing something that never actually took place. With advances in artificial intelligence, this problem is only getting worse.

Accordingly, new mechanisms for establishing authenticity of image content are desirable.

### SUMMARY

In accordance with some embodiments, systems, methods, and media for establishing authenticity of image content are provided. In some embodiments, systems for establishing authenticity of image content are provided, the systems comprising: memory; and at least one hardware processor couple to the memory and collectively configured to at least: capture an image using a camera; digitally sign the image using the camera to create a digital signature; and store a first copy of the image in remote storage with the digital signature. In some of these embodiments, the image and the digital signature are stored in a blockchain. In some of these embodiments, the at least one hardware processor is further collectively configured to: retrieve a second copy of the image; and determine whether the second copy of the image is authentic based on the digital signature. In some of these embodiments, the at least one hardware processor is further collectively configured to generate an indicator that indicates to a person whether the second copy of the image is authentic. In some of these embodiments, the at least one hardware processor is further collectively configured to: retrieve a second copy of the image; perform an editing operation on the second copy of the image to form an edited copy of the image; and store the edited copy of the image in the block chain. In some of these embodiments, the at least one hardware processor is further collectively configured to store an indicator of edits made in the edited copy in the blockchain. In some of these embodiments, the at least one hardware processor is further collectively configured to restrict which edit operations can be made in a third copy of the image.

In some embodiments, methods of establishing authenticity of image content are provided, the methods comprising: capturing an image using a camera; digitally signing the image using the camera to create a digital signature; and storing a first copy of the image in remote storage with the digital signature. In some of these embodiments, the image and the digital signature are stored in a blockchain. In some of these embodiments, the methods further comprise: retrieving a second copy of the image; and determining whether the second copy of the image is authentic based on the digital signature. In some of these embodiments, the methods further comprise generating an indicator that indicates to a person whether the second copy of the image is authentic. In some of these embodiments, the methods further comprise: retrieving a second copy of the image; performing an editing operation on the second copy of the image to form an edited copy of the image; and storing the edited copy of the image in the block chain. In some of these embodiments, the methods further comprise storing an indicator of edits made in the edited copy in the blockchain. In some of these embodiments, the methods further comprise restricting which edit operations can be made in a third copy of the image.

In some embodiments, non-transitory computer-readable media containing computer executable instructions that, when executed by a processor, cause the processor to perform a method of establishing authenticity of image content are provided, the method comprising: capturing an image using a camera; digitally signing the image using the camera to create a digital signature; and storing a first copy of the image in remote storage with the digital signature. In some of these embodiments, the image and the digital signature are stored in a blockchain. In some of these embodiments, the methods further comprise: retrieving a second copy of the image; and determining whether the second copy of the image is authentic based on the digital signature. In some of these embodiments, the methods further comprise generating an indicator that indicates to a person whether the second copy of the image is authentic. In some of these embodiments, the methods further comprise: retrieving a second copy of the image; performing an editing operation on the second copy of the image to form an edited copy of the image; and storing the edited copy of the image in the block chain. In some of these embodiments, the methods further comprise storing an indicator of edits made in the edited copy in the blockchain. In some of these embodiments, the methods further comprise restricting which edit operations can be made in a third copy of the image.

### BRIEF DESCRIPTION OF THE DRAWINGS

FIG. 1 is an example of a block diagram of components that can be used in some embodiments.

FIG. 2 is an example of a block diagram of hardware that can be used in some embodiments.

FIG. 3 is an example of a flow diagram of processes that can be used in some embodiments.

### DETAILED DESCRIPTION

In accordance with some embodiments, mechanisms, including systems, methods, and media, for establishing authenticity of image content are provided.

In accordance with some embodiments, to establish authenticity of images, a trusted camera can digitally sign images that it has taken. These signatures can be unique for each picture captured. These signatures can then serve as verifiable proof of the images' integrity and origin. By attaching digital signatures at the time of capture, tampering or manipulation attempts can be detected and prevented.

In some embodiments, the generated digital signatures can be stored securely within each image's metadata. Additionally or alternatively, in some embodiments, to enhance tamper resistance, a public tamper-proof storage system such as a blockchain can be utilized. This helps ensure that the signature remains linked to the image and can be easily accessed for verification purposes.

In some embodiments, to enable image editing while maintaining transparency, editing software can be record all changes made to the original image. In some embodiments, these changes can be stored along with descriptions detailing the modifications introduced. Furthermore, the descriptions can be digitally signed to establish their authenticity, in some embodiments. Additionally, in some embodiments, these signed descriptions can be stored in the blockchain or a similar tamper-proof storage system.

In some embodiments, to facilitate image authenticity verification, a dedicated verification service can be used. Any user seeking to verify the authenticity of an image can access this service, in some embodiments. In some embodiments, in response to a submitted image, a user can receive an authenticity certificate, which, in some embodiments, can include the image's digital signature and a comprehensive history of all changes made to the image. This transparency allows users to validate images' integrity and trace their modification journey.

In some embodiments, the proposed mechanisms present a comprehensive approach to combating misinformation by ensuring image authenticity and traceability. By leveraging digital signatures, image metadata, tamper-proof storage, and a verification service, the mechanisms empower users to verify the integrity of images and effectively identify any tampering attempts.

It should be noted that, while this description describes actions taken on images, these images can be part of a video (i.e., a video is a sequence of images) in some embodiments, and all techniques described herein can be applied to one, more, or all images in a video in some embodiments.

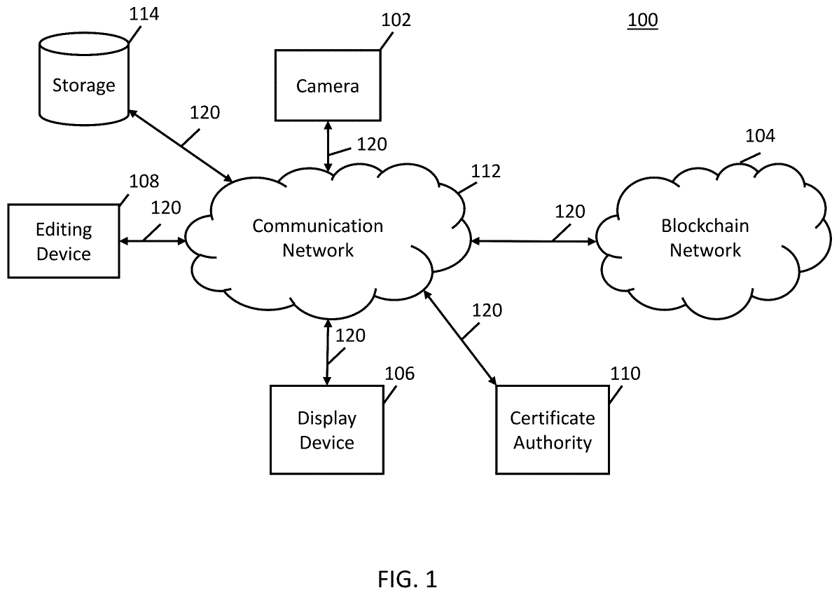

Turning to FIG. 1, an example 100 of hardware that can be used to implement mechanisms in accordance with some embodiments of the disclosed subject matter are shown. As illustrated, hardware 100 can include a camera 102, a blockchain network 104, a display device 106, an editing device 108, a certificate authority 110, a communication network 112, and storage 114.

Although one of each of camera 102, blockchain network 104, display device 106, editing device 108, certificate authority 110, communication network 112, and storage 114 are illustrated in FIG. 1, any suitable number(s) of each these, and any suitable additional or alternative devices, networks, or other mechanisms, can be used in some embodiments. For example, one or more additional devices, such as servers, computers, routers, networks, etc., can be included in some embodiments.

In some embodiments, any two or more of camera 102, blockchain network 104, display device 106, editing device 108, certificate authority 110, communication network 112, and storage 114 can be combined.

In some embodiments, one or more of camera 102, blockchain network 104, display device 106, editing device 108, certificate authority 110, communication network 112, and storage 114 can be omitted and/or some of the functionality described as being performed in one or more of 102, 104, 106, 108, 110, 112, and 114 can be performed in another of 102, 104, 106, 108, 110, 112, and 114.

Camera 102 can be any suitable camera capable of capturing, digitally signing, and sending images and/or video captured by camera 102, in some embodiments. Camera 102 can be a still camera, a video camera, a mobile phone with optical sensor, a computer (e.g., laptop, tablet, desktop, etc.) with camera, and/or any other suitable device capable of capturing images and/or video and digitally signing the images and/or video.

Blockchain network 104 can be any suitable network of devices (e.g., such as servers, computers, routers, communications devices, etc.) for maintaining one or more blockchains that can be used to establish the authenticity of image content. In some embodiments, blockchain network can additionally or alternatively be any suitable mechanism for storing digital signatures of images and/or editing data in a tamperproof manner.

Display device 106 can be any suitable device for receiving and displaying images and/or video, validating the images and/or video, determining whether images and/or video are authentic, indicating whether images and/or video are authentic, and/or indicating what edits have been made to images and/or video. For example, in some embodiments, display device 106 can be a still camera, a video camera, a mobile phone, a computer (e.g., laptop, tablet, desktop, etc.), and/or any other suitable device capable of displaying images and/or video.

Editing device 108 can be any suitable device for receiving, editing, and sending images and/or video and updating blockchains and/or metadata related to the editing of the images and/or video. For example, in some embodiments, display device 106 can be a mobile phone, a computer (e.g., laptop, tablet, desktop, etc.), and/or any other suitable device capable of receiving, editing, and sending images and/or video and updating blockchains and/or metadata related to the editing of the images and/or video.

Certificate authority 110 can be any suitable device for validating certificates of a camera, an editing device, a device in a blockchain network, a storage device, and/or any other suitable device.

Storage 114 can be any suitable device for receiving, storage, and sending images in a secure and tamperproof manner. For example, storage can be any suitable server.

Communication network 112 can be any suitable combination of one or more wired and/or wireless networks in some embodiments. For example, in some embodiments, communication network 112 can include any one or more of the Internet, a mobile data network, a satellite network, a local area network, a wide area network, a telephone network, a cable television network, a WiFi network, a WiMax network, and/or any other suitable communication network.

Camera 102, blockchain network 104, display device 106, editing device 108, certificate authority 110, and storage 114 can be connected by one or more communications links 120 to communication network 112. These communications links can be any communications links suitable for communicating data among camera 102, blockchain network 104, display device 106, editing device 108, certificate authority 110, storage 114, and communication network 112, such as network links, dial-up links, wireless links, hard-wired links, routers, switches, any other suitable communications links, or any suitable combination of such links.

In some embodiments, communication network 112 and the devices connected to it can form or be part of a wide area network (WAN) or a local area network (LAN).

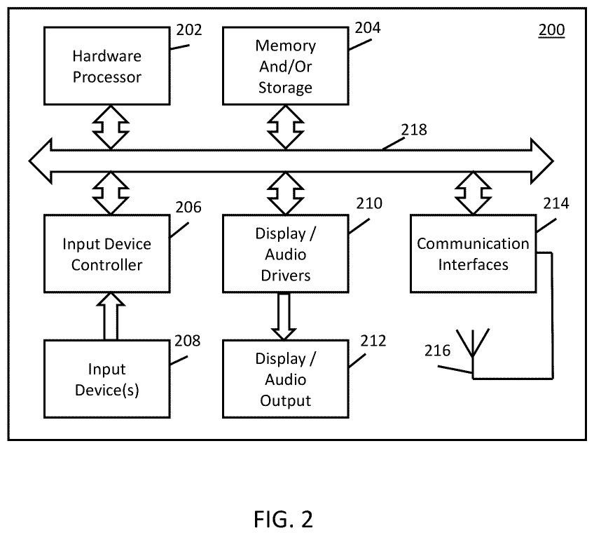

Camera 102, blockchain network 104, display device 106, editing device 108, certificate authority 110, and/or storage 114 can be implemented using any suitable hardware in some embodiments. For example, in some embodiments, camera 102, blockchain network 104, display device 106, editing device 108, certificate authority 110, and/or storage 114 can be implemented using any suitable general-purpose computer or special-purpose computer(s). For example, display device 106 can be implemented using a special-purpose computer, such as a smart phone. Any such general-purpose computer or special-purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a graphical processing unit (GPU), a microprocessor, a micro-controller, digital signal processor(s), dedicated logic, and/or any other suitable circuitry for controlling the functioning of a general-purpose computer or a special purpose computer in some embodiments.

Memory and/or storage 204 can be any suitable memory and/or storage for storing programs, data, and/or any other suitable information in some embodiments. For example, memory and/or storage 204 can include random access memory, read-only memory, flash memory, hard disk storage, optical media, and/or any other suitable memory.

Input device controller 206 can be any suitable circuitry for controlling and receiving input from input device(s) 208, in some embodiments. For example, input device controller 206 can be circuitry for receiving input from an input device 208, such as from a touch screen, from one or more buttons, from a voice recognition circuit, from a microphone, from a camera, from an optical sensor, from an accelerometer, from a temperature sensor, from a near field sensor, from an automobile navigation system, from a global positioning system, and/or any other type of input device.

Display/audio drivers 210 can be any suitable circuitry for controlling and driving output to one or more display/audio output circuitries 212 in some embodiments. For example, display/audio drivers 110 can be circuitry for driving one or more display/audio output circuitries 212, such as an LCD display, a speaker, an LED, or any other type of output device.

Communication interface(s) 214 can be any suitable circuitry for interfacing with one or more communication networks, such as communication network 112. For example, interface(s) 214 can include network interface card circuitry, wireless communication circuitry, and/or any other suitable type of communication network circuitry.

Antenna 216 can be any suitable one or more antennas for wirelessly communicating with a communication network in some embodiments. In some embodiments, antenna 216 can be omitted when not needed.

Bus 218 can be any suitable mechanism for communicating between two or more components 202, 204, 206, 210, and 214 in some embodiments.

Any other suitable components can additionally or alternatively be included in hardware 200 in accordance with some embodiments.

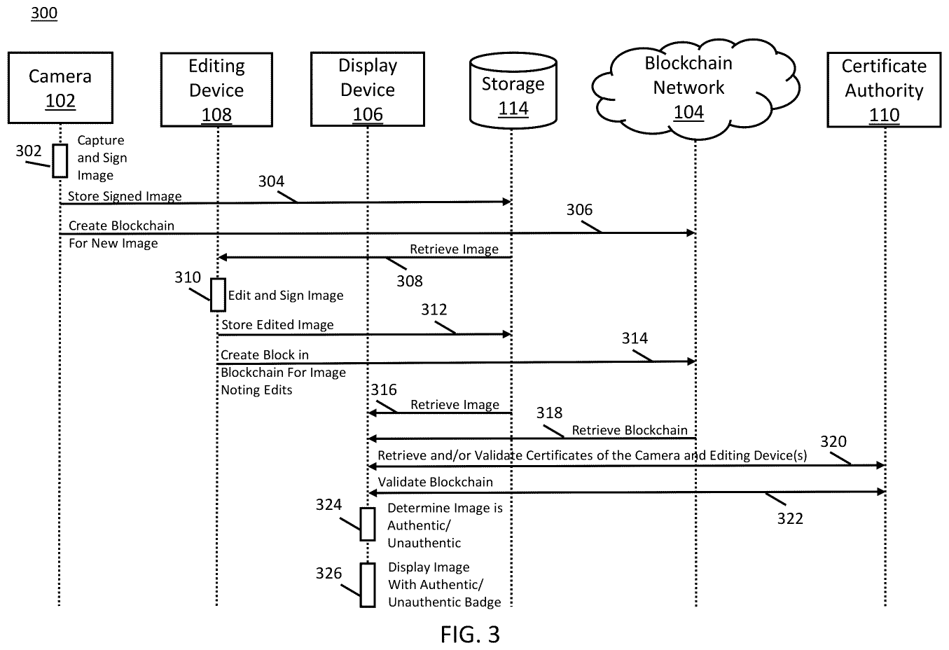

Turning to FIG. 3, an example 300 of a process for establishing authenticity of image content in accordance with some embodiments is illustrated.

As shown, process 300 can begin at 302 when camera 102 captures and digitally signs an image. Any suitable image can be captured and signed, in some embodiments. For example, the image can be a still image. As another example, the image can be part of video. In some embodiments, the image can have any suitable size, resolution, can be color or black and white, and have any other suitable characteristics. The image can be digitally signed in any suitable manner. For example, in some embodiments, the digital signature can be formed using asymmetric cryptography. More particularly, for example, in some embodiments, a hash of the image can be encrypted with a private key of the camera and attached to or otherwise associated with the digital image to digitally sign it.

Next, at 304, camera 102 can store the signed imaged in storage 114. The signed image can be stored in any suitable manner. For example, in some embodiments, the camera can store the signed image in storage 114 by uploading the signed image to storage 114.

In some embodiments, any suitable metadata can be attached to or stored with the image. For example, in some embodiments, metadata attached to or stored with the image can include an identifier of the image, a hash of the image, the camera's digital signature of the image, a copy of the image, an identifier of camera 102, a date and time the image was captured, an identifier of the person that captured the image, a location at which the image was captured (e.g., based on GPS data), and/or any other suitable information.

Then, at 306, the camera can create a blockchain for the image in blockchain network 104. Any suitable blockchain can be created and the blockchain can include any suitable content. For example, in some embodiments, the blockchain can include an identifier of the image, a hash of the image, the camera's digital signature of the image, a copy of the image, an identifier of camera 102, a date and time the image was captured, an identifier of the person that captured the image, a location at which the image was captured (e.g., based on GPS data), and/or any other suitable information.

In some embodiments, additionally or alternatively to creating a blockchain for the image, any other suitable tamperproof technology can be used to record the same or different information for the image.

When an image is to be edited, an editing device 108 can retrieve the image from storage 114. The image can be retrieved in any suitable manner, in some embodiments. For example, in some embodiments, the image can be retrieved by requesting the image from the storage using an identifier of the image.

Next, at 310, the editing device can edit and sign the image. In some embodiments, the editing may be restricted to certain allowable actions. For example, in some embodiments, the editing may be limited to denoising, tone-mapping, contrast enhancement, deblurring, edge sharpening, and/or any other suitable action that does not materially alter the content of the image. For example, in some embodiments, editing that may be prohibited can include adding, removing, or altering the appearance of an object, person, animal, location, background, and/or any other aspect of the image that materially alters the content of the image.

The image can be digitally signed in any suitable manner. For example, in some embodiments, the digital signature can be formed using asymmetric cryptography. More particularly, for example, in some embodiments, a hash of the image can be encrypted with a private key of the camera and attached to or otherwise associated with the digital image to digitally sign it.

Then, at 312, the edited image can be stored in storage 114. The edited image can be stored in any suitable manner. For example, in some embodiments, the editing device can store the signed image in storage 114 by uploading the signed image to storage 114. In some embodiments, the original image can be retained in storage 114 so that the images can be compared at a later time.

In some embodiments, any suitable metadata can be attached to or stored with the edited image. For example, in some embodiments, metadata attached to or stored with the edited image can include an identifier of the edited image, a hash of the edited image, the camera's digital signature of the original image, a copy of the edited image, a copy of the original image, a copy of one or more previous non-original versions of the image, an identifier of camera 102, a date and time the image was captured, a date and time for one or more of the instances in which the image was edited, an identifier of one or more of the persons that captured and/or edited the image, a location at which the image was captured (e.g., based on GPS data), one or more of the specific editing functions that we performed on the image, and/or any other suitable information.

At 314, the editing device can update the blockchain for the image in blockchain network 104. The blockchain can be updated in any suitable manner and the blockchain update can include any suitable content. For example, in some embodiments, the blockchain update can include an identifier of the edited image, a hash of the edited image, the camera's digital signature of the original image, a copy of the edited image, a copy of the original image, a copy of one or more previous non-original versions of the image, an identifier of camera 102, a date and time the image was captured, a date and time for one or more of the instances in which the image was edited, an identifier of one or more of the persons that captured and/or edited the image, a location at which the image was captured (e.g., based on GPS data), one or more of the specific editing functions that we performed on the image, and/or any other suitable information.

In some embodiments, additionally or alternatively to updating the blockchain for the image, any other suitable tamperproof technology can be used to record the same or different information for the image.

When the image is to be displayed, the image can be retrieved by a display device 106 from storage 114. The image can be retrieved in any suitable manner, in some embodiments. For example, in some embodiments, the image can be retrieved by requesting the image from the storage using an identifier of the image.

Next, at 318, the display device can retrieve the blockchain from blockchain network 104. The blockchain can be retrieved in any suitable manner, in some embodiments. For example, in some embodiments, the blockchain can be retrieved by requesting the blockchain from the blockchain network using an identifier of the image or the blockchain.

Next at 320, the display device can retrieve and/or validate the certificates of the camera and editing devices. The certificates can include any suitable information that can be used to authenticate the authenticity of the content of the image. For example, in some embodiments, the certificates can include public keys of the camera and editing devices.

Then at 322, the display device can validate the blockchain for the image. The blockchain can be validated in any suitable manner in some embodiments. For example, in some embodiments, each block of the blockchain can be validated by checking digital signatures on the block against the public keys of the device (e.g., camera or editing device) associated with the block.

At 324, the display device can determine if the image is authentic or unauthentic. This determination can be made in any suitable manner, in some embodiments. For example, in some embodiments, this determination can be made by determining that the digital signatures of the original and/or edited image, stored in metadata or the blockchain, match the public keys of the associated device(s) and that no prohibited editing actions were taken on the image.

In some embodiments, when a display device retrieves an image from an untrusted source, the image can be determined to be authentic by retrieving a copy of the original image from storage 114 and comparing the two images to confirm that the image is authentic. This comparison can be performed in any suitable manner. For example, in some embodiments, if the images are identical, this comparison can determine that the image is authentic. As another example, in some embodiments, if the images are not identical, the image from the untrusted source can be analyzed to determine if edits made to the image are permitted, and, if so, that the image is authentic.

Finally, at 326, the display device can display the image with a badge indicating that the image is authentic or unauthentic. Any suitable badge can be used, and the badge can be presented in any suitable manner, in some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for establishing authenticity of image content, comprising:
memory; and
at least one hardware processor couple to the memory and collectively configured to at least:
capture an image using a camera;
digitally sign the image using the camera to create a digital signature; and
store a first copy of the image in remote storage with the digital signature.

2. The system of claim 1, wherein the image and the digital signature are stored in a blockchain.

3. The system of claim 1, wherein the at least one hardware processor is further collectively configured to:
retrieve a second copy of the image; and
determine whether the second copy of the image is authentic based on the digital signature.

4. The system of claim 1, wherein the at least one hardware processor is further collectively configured to generate an indicator that indicates to a person whether the second copy of the image is authentic.

5. The system of claim 1, wherein the at least one hardware processor is further collectively configured to:
retrieve a second copy of the image;
perform an editing operation on the second copy of the image to form an edited copy of the image; and
store the edited copy of the image in the block chain.

6. The system of claim 5, wherein the at least one hardware processor is further collectively configured to store an indicator of edits made in the edited copy in the blockchain.

7. The system of claim 1, wherein the at least one hardware processor is further collectively configured to restrict which edit operations can be made in a third copy of the image.

8. A method of establishing authenticity of image content, comprising:
capturing an image using a camera;
digitally signing the image using the camera to create a digital signature; and
storing a first copy of the image in remote storage with the digital signature.

9. The method of claim 1, wherein the image and the digital signature are stored in a blockchain.

10. The method of claim 1, further comprising:
retrieving a second copy of the image; and
determining whether the second copy of the image is authentic based on the digital signature.

11. The method of claim 1, further comprising generating an indicator that indicates to a person whether the second copy of the image is authentic.

12. The method of claim 1, further comprising:
retrieving a second copy of the image;
performing an editing operation on the second copy of the image to form an edited copy of the image; and
storing the edited copy of the image in the block chain.

13. The method of claim 5, further comprising storing an indicator of edits made in the edited copy in the blockchain.

14. The method of claim 1, further comprising restricting which edit operations can be made in a third copy of the image.

15. A non-transitory computer-readable medium containing computer executable instructions that, when executed by a processor, cause the processor to perform a method of establishing authenticity of image content, the method comprising:
capturing an image using a camera;
digitally signing the image using the camera to create a digital signature; and
storing a first copy of the image in remote storage with the digital signature.

16. The non-transitory computer-readable medium of claim 1, wherein the image and the digital signature are stored in a blockchain.

17. The non-transitory computer-readable medium of claim 1, wherein the method further comprises:
retrieving a second copy of the image; and
determining whether the second copy of the image is authentic based on the digital signature.

18. The non-transitory computer-readable medium of claim 1, wherein the method further comprises generating an indicator that indicates to a person whether the second copy of the image is authentic.

19. The non-transitory computer-readable medium of claim 1, wherein the method further comprises:
retrieving a second copy of the image;
performing an editing operation on the second copy of the image to form an edited copy of the image; and
storing the edited copy of the image in the block chain.

20. The non-transitory computer-readable medium of claim 5, wherein the method further comprises storing an indicator of edits made in the edited copy in the blockchain.
